(19) United States
(12) Patent Application Publication
(10) Pub. No.: US 2023/0230470 A1
(43) Pub. Date: Jul. 20, 2023

(54) METHOD AND DEVICE FOR CONTROLLING KEY

(71) Applicant: Tuneit Inc., Seongnam-si (KR)

(72) Inventors: Sunhoon KIM, Yongin-si (KR); Wansoo KIM, Yongin-si (KR); Kichang YI, Suwon-si (KR)

(21) Appl. No.: 17/603,053

(22) PCT Filed: Jan. 11, 2021
(86) PCT No.: PCT/KR2021/000295

§ 371 Date: Oct. 12, 2021

(30) Foreign Application Priority Data
Sep. 29, 2020 (KR) 10-2020-0127348

(51) Int. Cl. G08C 17/02

(52) U.S. Cl. CPC G08C 17/02

(57) ABSTRACT

A key control method and a key control device are provided. A key control method includes: receiving a user input from a user; detecting whether a touch up event or a touch down event has occurred in the user input; and transmitting a first button driving signal to a key control device when the touch up event or the touch down event occurs, wherein the key control device includes at least one button for controlling another device, and the first button driving signal controls the at least one button.

### TECHNICAL FIELD

The present invention relates to a key control method and key control device.

### BACKGROUND ART

Currently, a key for a vehicle implements various functions for vehicle control such as opening and closing a trunk or remote starting as well as locking/unlocking a vehicle door. However, the number of buttons that can be mounted on the car key may be limited due to the requirements for portability. Accordingly, in order to implement various functions with only a limited number of buttons, a case where one button is pressed short and a case where a button is pressed long are distinguished and implemented to perform different functions. In addition, various electronic devices other than the vehicle are also using the remote control to turn on/off the power and set or change the settings remotely. In this specification, the term “key” may mean a remote control for a vehicle, but is used to include all remote controls that can remotely control various other electronic devices.

Meanwhile, as mobile devices such as smart phones or wearable devices like smart watches are widely used, technologies for controlling vehicles or electronic devices from such mobile devices or wearable devices are attracting attention, and it is now possible to control vehicles or electronic devices without having to always carry the physical key. However, such a technology often does not have wide compatibility due to the fact that specific control or operation methods are different for each manufacturer of a vehicle or electronic device.

For example, the time duration required for recognizing a case in which a button is pressed may be different for each manufacturer, and the number of mounted buttons may also be different. Therefore, there is a need for a method for controlling a vehicle or an electronic device in a mobile device or a wearable device regardless of a difference in control or operation method for each manufacturer.

### DISCLOSURE

### Technical Problem

The problem to be solved by the present invention is to provide a key control method and a key control device that can provide the same user experience as using a physical key when controlling a vehicle or electronic device from a mobile device or wearable device.

### Technical Solution

A key control method according to an embodiment of the present invention includes: receiving a user input from a user; detecting whether a touch up event or a touch down event has occurred in the user input; and transmitting a first button driving signal to a key control device when the touch up event or the touch down event occurs, wherein the key control device includes at least one button for controlling another device, and the first button driving signal controls the at least one button.

The transmitting may include, when the touch down event has occurred, transmitting a signal including the touch down event to the key control device as the first button driving signal.

The transmitting may include, when the touch up event has occurred, transmitting a signal including the touch up event to the key control device as the first button driving signal.

The at least one button may include a first button and a second button, and the transmitting may include: (i) when a touch down event for the first button occurs, transmitting a signal including the touch down event for the first button to the key control device as the first button driving signal; and (ii) in the (i), when a touch down event for the second button occurs, transmitting a signal including a touch down event for the second button to the key control device as the first button driving signal, together with a signal including the touch down event for the first button.

The transmitting may include (iii), in the (ii), when a touch up event for the first button occurs, transmitting a signal including the touch up button for the first button to the key control device as the first button driving signal, together with a signal including a touch down event for the second button.

The transmitting may include: (iv), in the (iii), when a touch up event for the second button occurs, transmitting a signal including a touch up event for the second button to the key control device as the first button driving signal.

The transmitting may include: when the touch down event occurs, iteratively transmitting a signal including the touch down event at a predetermined time interval to the key control device as the first button driving signal; and when the touch up event occurs, transmitting a signal including the touch up event the to the key control device as the first button driving signal.

A key control device according to an embodiment of the present invention includes: a remote controller control device that receives a first button driving signal including a touch up event or a touch down event from a user device through a communication module, and outputs a second button driving signal according to the touch up event or the touch down event; and a remote controller circuit that controls another device by applying the second button driving signal received from the remote controller control device to at least one button.

The remote controller control device may output a button-on signal for switching the at least one button to an on-state as the second button driving signal, when receiving the touch down event.

The remote controller control device may output a button-off signal for switching the at least one button to an off-state as the second button driving signal, when receiving the touch up event.

The at least one button may include a first button and a second button, the remote controller control device may output a first button-on signal for switching the first button to an on-state as the second button driving signal when receiving the touch down event, and when receiving the touch down event for the second button while outputting the first button-on signal, the remote controller control device may output a second button-on signal for switching the second button to the on-state as the second button driving signal, together with the first button-on signal.

When receiving the touch up event for the first button after outputting the first button-on signal and the second button-on signal, the remote controller control device may output a first button off signal for switching the first button to an off-state as the second button driving signal, together with the second button on signal.

When receiving the touch up event for the first button after outputting the first button-off signal and the second button-on signal, the remote controller control device may output a second button off signal for switching the second button to an off-state as the second button driving signal.

When not receiving a first button driving signal from a user device for a predetermined time period, the remote controller control device may output a button-off signal for switching the at least one button to an off-state.

When detecting a connection loss with the user device, the remote controller control device may output a button-off signal for switching the at least one button to an off-state.

When detecting a data loss for a first button driving signal transmitted from a user device, the remote controller control device may output a button-off signal for switching the at least one button to an off-state.

When continuously receiving a touch down event over a predetermined time, the remote controller control device may output a button-off signal for switching the at least one button to an off-state.

### Advantageous Effects

According to the embodiments of the present invention, when controlling a vehicle or electronic device from a mobile device or a wearable device using a key, not only providing the same user experience as a physical key, but also a function can be used for general purposes regardless of the difference in vehicle control methods by different vehicle manufacturers can be provided.

Specifically, when receiving a touch down event or touch up event with a user input, the user device provides a first button driving signal including the touch down event or touch up event to the key control device, and when receiving the first button driving signal, the key control device may immediately control the other device through a remote controller circuit, shortening a time taken for the operation of the other device from the user input, and reacting immediately to the user input, can be implemented to provide the user with the same user experience as the physical key.

Furthermore, when implementing a function that requires a long press of a physical key, how long to press a key corresponds to different detailed specifications for each manufacturer of the device under control, and when the method described in the present embodiment is applied, the user can directly control the button press time duration without having to develop an application mounted on the user device for each manufacturer, thereby reducing the development complexity and greatly increasing compatibility of the application of the user device and the key control device.

In addition, unlike the detailed specifications set by the manufacturer, problems such as when the user clicks or touches excessively quickly, the key control device may omit some of the events, and the user’s input does not reach the key control device correctly, can be prevented. In addition, compared to the conventional method of adding a delay section to solve the problems, the user input can accurately reach the key control device without sacrificing the time it takes from the user input to the operation of the other device.

### DESCRIPTION OF THE DRAWINGS

FIG. 1 is provided for description of a key control system according to an embodiment of the present invention.

FIG. 2 is provided for description of the key control device according to the embodiment of the present invention.

FIG. 3 is provided for description of a kay control method according to an embodiment of the present invention.

FIG. 4 is provided for description of a key control method according to an embodiment of the present invention.

FIG. 5 is provided for description of a key control method according to an embodiment of the present invention.

FIG. 6 is provided for description of a key control method according to an embodiment of the present invention.

FIG. 7 is provided for description of a key control method according to an embodiment of the present invention.

FIG. 8 is provided for description of a key control method according to an embodiment of the present invention.

FIG. 9 is provided for description of a key control method according to an embodiment of the present invention.

FIG. 10 is a block diagram for description of a computing device for implementing a key control method, a key control device, and a user device according to an embodiment of the present invention.

### MODE FOR INVENTION

The present invention will be described more fully hereinafter with reference to the accompanying drawings, in which embodiments of the invention are shown. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, throughout the specification and claims, unless explicitly described to the contrary, the word “comprise” and variations such as “comprises” or “comprising” will be understood to imply the inclusion of stated elements but not the exclusion of any other elements. In addition, terms such as “...part”, “...group”, and “module” described in the specification mean a unit that processes at least one function or operation, and can be implemented as a combination of hardware or software or hardware and software. In addition, at least some of a key control method, a key control device, and a user device according to embodiments described below may be implemented as a program or software, and the program or software may be stored in a computer-readable medium.

In the present specification, the term “key” may mean a remote control for a vehicle, but is used to include all remote controls that can remotely control various other electronic devices. The term “key” may be used interchangeably with the term “remote control”.

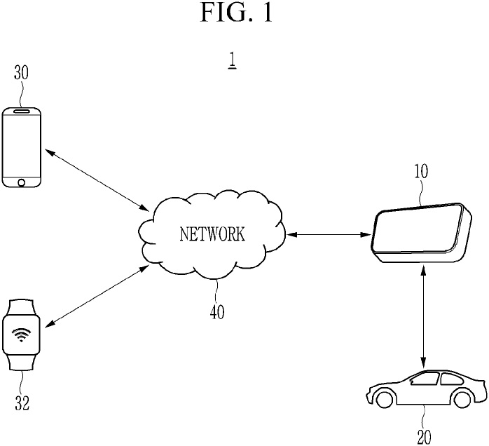

FIG. 1 is provided for description of a key control system according to an embodiment of the present invention.

Referring to FIG. 1, a control system 1 according to an embodiment of the present invention may include a key control device 10, another device 20 controller controlled by the key control device 10, and user devices 30 and 32 that can control the key control device 10.

First, a case that the other device 20 is a vehicle will be mainly described for convenience of description in the present embodiment. That is, in the present embodiment, a case that a user controls the device 20, that is, a vehicle, by using the key control device 10 will be described. However, the scope of the present invention is not limited thereto, and various configurations and features of the present invention to be described below may be applied to any electronic device that can be operated through a remote control operation. As will be described later, the key control device 10 controls another device 20 using a remote controller circuit 14 corresponding to a physical remote control. In this case, the remote controller circuit 14 may be a remote controller circuit for a vehicle, but it may be a remote controller circuit for any electronic device. As an example of such an electronic device, various home appliances controllable with a remote control such as an air conditioner, a fan, a vacuum cleaner, a refrigerator, and the like may be mentioned, but the scope of the present invention is not limited thereto.

The user devices 30 and 32 can run an application that allows the user to operate another device 20 using the key control device 10. The user devices 30 and 32 may be implemented as a mobile device or a wearable device having a user input interface and a processor, and the application may be executed on the processor, but the scope of the present invention is not limited thereto, and the user devices 30 and 32 may be implemented in any computing device.

The user devices 30 and 32 may receive a user input from a user through a user input interface. For example, the user devices 30 and 32 may receive a touch input or a gesture input input by a user on a touch panel using a user input interface. In addition, the user devices 30 and 32 may detect whether an event occurs in the user input using the processor.

For example, the user devices 30 and 32 may detect whether a click event occurs in the user input, that is, whether a touch up event or a touch down event occurs by using the processor. Here, the touch up event is an event that occurs when the user touches and then releases a specific item displayed on the touch panel, for example, with a finger, and the touch down event is an event that occurs as soon as the user touches a specific item displayed on the touch panel. When the touch up event or the touch down event occurs, the user devices 30 and 32 may transmit a first button driving signal for driving the key control device 10 to the key control device 10. For example, when the user touches a remote starting button image displayed on the user devices 30 and 32, the application can detect whether a touch down event occurs as a click event, and the application can initiate remote starting for the key control device 10 to start the vehicle by transmitting a first button driving signal related to remote starting to the control device 10 according to the touch down event.

Here, the first button driving signal may include a touch up event or a touch down event. In addition, the first button driving signal may include a touch up event or a touch down event for a specific button. For example, the first button driving signal may include a touch up event for a first button, a touch down event for the first button, a touch up event for a second button, which is different from the first button, a touch down event for the second button, and the like.

The user devices 30 and 32 may transmit the first button driving signal to the key control device 10 through a network 40. In the present embodiment, the network 40 may include a wireless fidelity (Wi-Fi) network, a mobile communication network including 3G, 4G, and 5G, a wireless network including a Bluetooth network, a wireless network including a local area network (LAN), or a combination of a wireless network and a wired network, but the scope of the present invention is not limited thereto, and the network 40 may include any type of network in which the key control device 10 and the user devices 30 and 32 can exchange data.

The key control device 10 may control the device 20 according to the first button driving signal received from the user devices 30 and 32. Thus, the key control device 10 may include a remote controller control device 12 and a remote controller circuit 14.

The remote controller control device 12 may control the remote controller circuit 14 according to the first button driving signal received from the user devices 30 and 32, and the remote controller control device 12 and the remote controller circuit 14 may be packaged into one case and can be installed inside or outside the other device 20 as the key control device 10.

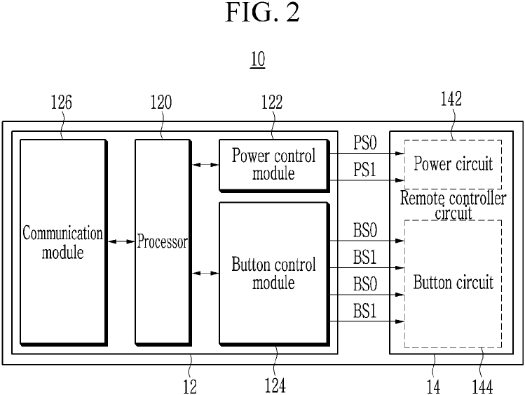

Hereinafter, the key control device 10 will be described in more detail with reference to FIG. 2.

FIG. 2 is provided for description of the key control device according to the embodiment of the present invention.

Referring to FIG. 2, the key control device 10 may include the remote controller control device 12 and the remote controller circuit 14.

The remote controller circuit 14 may be a physical remote controller that is manufactured to correspond to a vehicle or any electronic device. Specifically, the remote controller circuit 140 may include a printed circuit board (PCB) mounted inside the physical remote controller. The PCB may include a power circuit 142, a button circuit 144, and other circuit elements. The power circuit 142 and the button circuit 144 are components that are generally included in the PCB regardless of a manufacturer of the vehicle or electronic device, and detailed specifications such as a detailed control or operation method of the remote controller circuit 14 and the number of mounted buttons may be different for each manufacturer of the electronic device.

The power circuit 142 is a circuit for supplying power to the remote controller circuit 14, and the power circuit 142 may receive power from a battery or may receive power from the remote controller control device 12 as described below. To this end, the power circuit 142 may include a plurality of terminals including a positive terminal and a negative terminal.

The button circuit 144 may refer to a circuit in which at least one button for operating the remote controller circuit 14 is disposed. When the remote controller circuit 14 is used by itself, the user can control the device 20 by directly pressing a button disposed to the button circuit 144, but unlike the button circuit 144, the remote controller control device 20 may be controlled by generating the effect of pressing at least one button upon receiving the driving signal from 12 as described below. To this end, the button circuit 144 may include a plurality of terminals for receiving a driving signal from the remote controller control device 12.

In addition, the remote controller circuit 14 may include a communication module (not shown) for communicating with the device 20. For example, the remote controller circuit 14 may transmit an instruction to the device 20 using a radio frequency (RF) signal having a frequency of a predetermined value or range through the communication module. The scope of the present invention is not limited thereto, and the remote controller circuit 14 may be implemented to control the device 20 using other types of signals.

Previously, referring to FIG. 1, it has been described that the remote controller control device 12 and the remote controller circuit 14 are packaged in one case and thus may be installed inside or outside the device 20 as the key control device 10, but in this case, the key control device 10 may be installed inside or outside the device 20 within a distance capable of communicating, for example, through an RF signal.

The remote controller control device 12 may output a second button driving signal to the remote controller circuit 14 according to the first button driving signal received from the user devices 30 and 32. To this end, the remote controller control device 12 may include a processor 120, a power control module 122, a button control module 144, and a communication module 126.

Here, the second button driving signal may imply a button-on signal for converting at least one button of the remote controller circuit 14 to the on-state when the first button driving signal includes a touch down event.

Alternatively, the second button driving signal may imply a button-off signal for converting at least one button of the remote controller circuit 14 to the off-state when the first button driving signal includes a touch up event.

Alternatively, the second button driving signal may imply a first button-on signal for converting a first button among at least one of buttons of the remote controller circuit 14 to the on-state when the first button driving signal includes a touch down event with respect to the first. In addition, the second button driving signal may imply a first button-off signal for converting the first button among at least one of buttons of the remote controller circuit 14 to the off-state when the first button driving signal includes a touch up event with respect to the first.

Alternatively, when the first button driving signal includes a touch down event with respect to a second button that is different from the first button, the second button driving signal may imply a second button-on signal for converting a second button among at least one of buttons of the remote controller circuit 14 to the on-state. In addition, when the first button driving signal includes a touch up event with respect to the second button, the second button driving signal may imply a first button-off signal for converting the second button among at least one of buttons of the remote controller circuit 14 to the off-state.

The processor 120 controls the remote controller control device 12 overall, and may perform a specific operation of outputting the second button driving signal to the remote controller circuit 14 according to the first button driving signal received from the user devices 30 and 32.

The power control module 122 may provide power to the remote controller circuit 14. Specifically, the power control module 122 may provide power to the remote controller circuit 14 through terminals and circuit elements equipped in the power circuit 142. To this end, the power control module 122 may provide voltages PS0 and PS1 to the power circuit 142. Depending on the value of the power voltages PS0 and PS1, the remote controller circuit 14 may be turned on or off.

The button control module 124 may provide second button driving signals BS0, BS1, BS2, and BS3 as driving signals to the remote controller circuit 14. Here, when the touch up event or the touch down event occurs, the second button driving signals BS0, BS1, BS2, and BS3 may imply a signal for driving at least one of buttons of the remote controller circuit 14, output by the remote controller control device 12 to the remote controller circuit 14 corresponding to the first button driving signal transmitted by applications of the user devices 30 and 32. In FIG. 2, only four second button driving signals are shown, for example, when the remote controller control device 12 controls four buttons, but the scope of the present invention is not limited thereto.

The remote controller control device 12 may receive the first button driving signal from the user devices 30 and 32 through the communication module 126. In the present embodiment, the remote controller control device 12 may receive the first button driving signal from the user devices 30 and 32 through the communication module 126 implemented to access a Wi-Fi network, a mobile communication network including 3G, 4G, and 5G, a wireless network including a Bluetooth network, a wireless network including a LAN, or a combination of wireless network and wired network, but the scope of the present invention is not limited thereto.

Meanwhile, the remote controller control device 12 may receive power through a battery or from the outside. When the remote controller control device 12 receives power from the outside, for example, when the key control device 10 is installed inside a vehicle, the remote controller control device 12 may be supplied with power from the vehicle, and when the key control device 10 is installed outside an air conditioner controller, the remote controller control device 12 may be supplied with power from the air conditioner or a power supply provided adjacent to the air conditioner.

According to the contents described with reference to FIG. 1 and FIG. 2, in one scenario, the application executed in the user devices 30 and 32 may display a remote starting button image of the vehicle on touch panels of the user devices 30 and 32. When the user clicks or touches the remote starting button image, the application may detect whether a click event or a touch event (touch up event or touch down event) occurs.

When detecting that a click event or a touch event has occurred, the application may transmit the first button driving signal including the corresponding event to the key control device 10.

The first button driving signal transmitted by the application is received by the remote controller control device 12 through the communication module 126, and the remote controller control device 12 transmits the second button driving signal to the remote controller circuit 14 according to a touch up event or a touch down event. Here, the second button driving signal may imply a signal for turning a button disposed for remote starting in the physical remote controller circuit 14 into the on or off state.

Accordingly, the remote controller circuit 14 may perform remote starting control for the vehicle.

In another scenario, the application running on the user devices 30 and 32 may display a remote power start button of the vehicle on the touch panels of user devices 30 and 32. When the user clicks or touches the remote power start button image, the application may detect whether a click event or a touch event (touch up event or touch down event) occurs.

When detecting that a click event or a touch event has occurred, the application may transmit the first button driving signal including the corresponding event to the key control device 10.

The first button driving signal transmitted by the application is received by the remote controller control device 12 through the communication module 126, and the remote controller control device 12 may output the second button driving signal to the remote controller circuit 14 according to the touch up event or touch down event. Here, the second button driving signal may imply a signal for turning a button disposed for remote power starting in the physical remote controller circuit 14 into the on or off state.

Accordingly, the remote controller circuit 14 may perform remote power start control for the air conditioner.

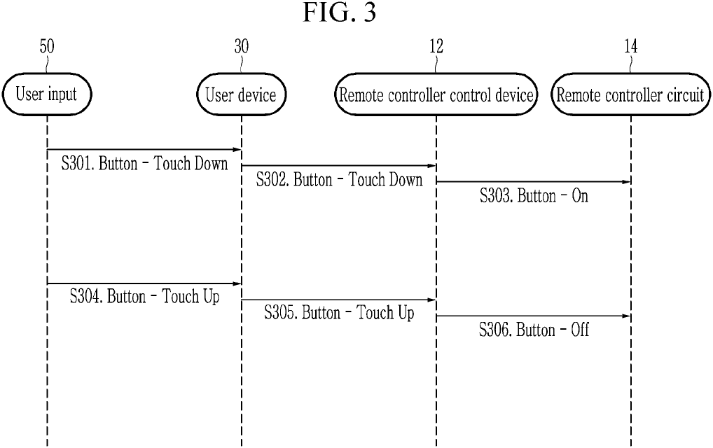

Hereinafter, a key control method according to an embodiment of the present invention will be described in detail with reference to FIG. 3 to FIG. 9.

FIG. 3 is provided for description of a kay control method according to an embodiment of the present invention.

Referring to FIG. 3, in a key control method according to an embodiment of the present invention, a touch down event for at least one buttons of the key control device 10 (specifically, the remote controller circuit 14) may occur as a user input 50. Specifically, the user may touch down the touch panels of the user devices 30 and 32 to generate a touch down event for at least one of buttons (S301).

The user device 30 may detect occurrence of the touch down event in the user input 50, and accordingly, the first button driving signal for driving the key control device 10 may be transmitted to the key control device 10. Specifically, the user device 30 may transmit the first button signal to the remote controller control device 12 through the communication module 126 (S302). Here, the first button driving signal may include a touch down event for at least one button.

The remote controller control device 12 may output the second button driving signal to the remote controller circuit 14 according to the first button driving signal received from the user devices 30 and 32. Here, as the first button driving signal includes the touch down event, and the second button driving signal may imply a button-on signal for converting at least one button of the remote controller circuit 14 to the on-state (S303).

When receiving the button-on signal, the remote controller circuit 41 may perform an operation assigned to at least one button for another device 20. For example, when the operation assigned to the at least one button is remote starting for the vehicle, the remote controller circuit 41 may perform remote starting for the vehicle using, for example, an RF signal, and as another example, when the operation assigned to at least one button is remote power starting for the air conditioner, the remote controller circuit 41 may perform remote power start for the air conditioner using, for example, an RF signal.

Subsequently, as the user input 50, a touch up event for at least one button may occur. Specifically, the user may touch up the touch panel of the user devices 30 and 32 to generate a touch up event for at least one button as the user input 50 (S304).

The user device 30 may detect the occurrence of a touch up event in the user input 50, and accordingly, may transmit the first button driving signal for driving the key control device 10 to the key control device 10. Specifically, the user device 30 may transmit the first button signal to the remote controller control device 12 through the communication module 126 (S305). Here, the first button driving signal may include a touch up event for at least one button.

The remote controller control device 12 may output a second button driving signal to the remote controller circuit 14 according to the first button driving signal received from the user devices 30 and 32. Here, as the first button driving signal includes a touch up event, the second button driving signal may imply a button-off signal for converting at least one button of the remote controller circuit 14 to the off-state (S306).

When receiving the button-off signal, the remote controller circuit 41 may perform an operation assigned to at least one button for another device 20. For example, when the operation assigned to the at least one button is remote starting for the vehicle, the remote controller circuit 41 may stop or terminate the remote starting for the vehicle using, for example, an RF signal, and as another example, when the operation assigned to the at least one button is remote power start for the air conditioner, the remote controller circuit 41 may stop or terminate the remote power start for the air conditioner using, for example, an RF signal.

According to the present embodiment, when a touch down event or touch up event occurs with the user input 50, the user device 30 provides a first button driving signal including the touch down event or touch up event to the key control device 1, and when receiving the first button driving signal, the key control device 1 may immediately control the other device 20 through the remote controller circuit 14, shortening a time taken for the operation of the other device 20 from the user input 50, and immediate reaction to the user input 50 can be implemented to provide the user with the same user experience as actually controlling the physical key.

Furthermore, when implementing a function that requires a long press of a physical key to operate, how long to press a key corresponds to different detailed specifications for each manufacturer of the other device 20, and when the method described in the present embodiment is applied, the user can directly control the button press time without having to develop an application mounted on the user device 30 for each manufacturer, thereby reducing the development complexity and greatly increasing compatibility of the application of the user device 30 and the key control device 10.

In addition, unlike the detailed specifications set by the manufacturer, problems such as when the user clicks or touches excessively quickly, the key control device 10 may omit some of the events, and the user’s input does not reach the key control device 10 correctly can be prevented. In addition, compared to the conventional method of adding a delay section to solve the problems, the user input can accurately reach the key control device 10 without sacrificing the time it takes from the user input 50 to the operation of the other device 20.

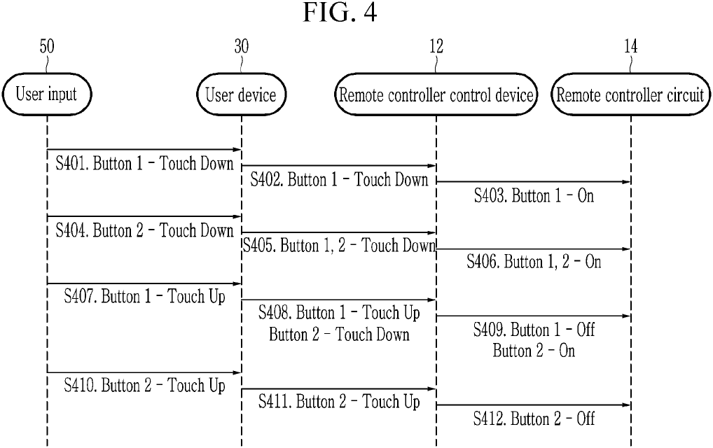

FIG. 4 is provided for description of a key control method according to an embodiment of the present invention.

Referring to FIG. 4, in a key control method for multiple touches according to an embodiment of the present invention, a touch down event for a first button of the remote controller circuit 14 of the key control device 10 may occur as a user input 50 (S401). In addition, as a first button driving signal for driving the key control device 10, the user device 30 may transmit a signal including a touch down event for the first button to the remote controller control circuit 12 of the key control device 10 (S402). Next, as a second button driving signal, the remote controller control circuit 12 may output a first button on signal for converting the first button to the on-state to the remote controller circuit 14 (S403).

Subsequently, as a user input 50 by the user’s multi-touch, a touch down event for a second button of the remote controller circuit 14 among the key control devices 10 may occur (S404). In addition, as a first button driving signal for driving the key control device 10, the user device 30 may transmit a signal including a touch down event for the second button and a signal including a touch down event for the first button to the remote controller control circuit 12 (S405). Next, the remote controller control circuit 12 may output a second button-on signal as a second button driving signal for switching the second button to the on-state to the remote controller circuit 14 together with the first button-on signal (S406).

Subsequently, as the user input 50 by the user’s multi-touch, a touch up event for the first button of the remote controller circuit 14 of the key control devices 10 may occur (S407). In addition, the user device 30 may transmit a signal including a touch up event for the first button as a first button driving signal for driving the key control device 10 to the remote controller control circuit 12 of the key control device 10, together with a signal including a touch down event for the second button (S408). Next, as a second button driving signal, the remote controller control circuit 12 may output a first button-off signal for switching the first button to the off-state to the remote controller circuit 14 together with a second button-on signal (S409).

Subsequently, as the user input 50 by the user’s multi-touch, a touch up event for the second button of the remote controller circuit 14 of the key control devices 10 may occur (S410). In addition, the user device 30 may transmit a signal including a touch up event for the second button as the first button driving signal for driving the key control device 10 to the remote controller control circuit 12 of the key control device 10 (S411). Next, as a second button driving signal, the remote controller control circuit 12 may output a second button off signal for switching the second button to the off-state to the remote controller circuit 14 together with the second button-on signal (S412).

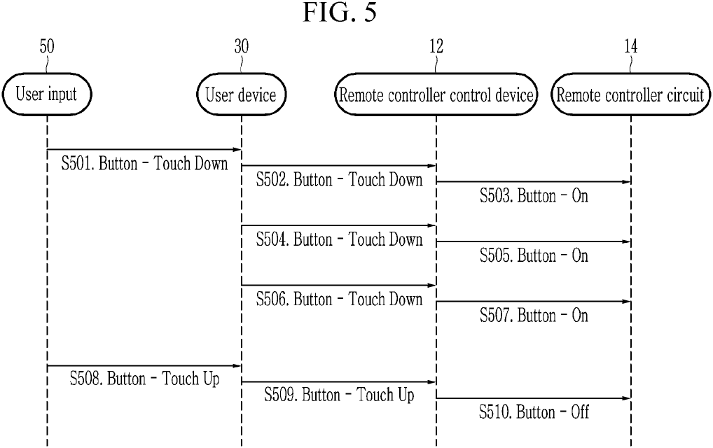

FIG. 5 is provided for description of a key control method according to an embodiment of the present invention.

Referring to FIG. 5, in a key control method for assuring validity according to an embodiment of the present invention, as a user input 50, a touch down event for at least one button of the key control device 10 (specifically, the remote controller circuit 14) may occur (S501).

The user device 30 may detect occurrence of the touch down event in the user input 50, and accordingly, a first button driving signal for driving the key control device 10 may be transmitted to the key control device 10. Specifically, the user device 30 may transmit a first button signal to the remote controller control device 12 through the communication module 126 (S502). Here, the first button driving signal may include a touch down event for the at least one button.

The remote controller control device 12 may output a second button driving signal to the remote controller circuit 14 according to the first button driving signal received from the user devices 30 and 32. Here, as the first button driving signal includes the touch down event, the second button driving signal may imply a button-on signal for converting at least one button of the remote controller circuit 14 to the on-state (S503).

In the present embodiment, in order to assure validity of the touch down event until before a touch up event occurs in the user input 50, when a touch down event occurs, the user device 30 may iteratively transmit a signal including the touch down event as the first button driving signal at a predetermined time interval to the remote controller control device 12 of the key control devices 10 (S502, S504, and S506). Accordingly, the remote controller control device 12 may also iteratively transmit a button-on signal as a second button driving signal at a predetermined time interval to the remote controller circuit 14 (S503, S505, and S507).

When a touch up event occurs during the iterative transmission, the user device 30 may transmit a signal including the touch up event, as a first button driving signal, to the remote controller control device 12 of the control devices 10 (S508 and S509). Accordingly, the remote controller control device 12 may also transmit a button-off signal as the second button driving signal to the remote controller circuit 14 (S510).

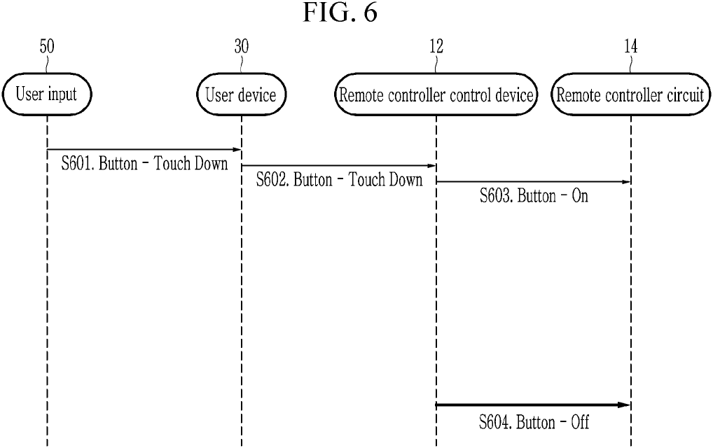

FIG. 6 is provided for description of a key control method according to an embodiment of the present invention.

Referring to FIG. 6, in a key control method for exception handling according to an embodiment of the present invention, the remote controller control device 12 may output a button-off signal for switching at least one button to an off state to the remote controller circuit 14 when the first button driving signal is not received from the user device 30 for a predetermined time period.

Specifically, as a user input 50, a touch down event for at least one button of the key control device 10 (specifically, the remote controller circuit 14) may occur (S601).

The user device 30 may detect occurrence of a touch down event in the user input 50, and accordingly, may transmit a first button driving signal for driving the key control device 10 to the key control device 10. Specifically, the user device 30 may transmit the first button signal to the remote controller control device 12 through the communication module 126 (S602). Here, the first button driving signal may include a touch down event for at least one button.

The remote controller control device 12 may output a second button driving signal to the remote controller circuit 14 according to the first button driving signal received from the user devices 30 and 32. Here, as the first button driving signal includes a touch down event, the second button driving signal may imply a button-on signal for converting at least one button of the remote controller circuit 14 to the on-state (S603).

However, when the first button driving signal, for example, the first button driving signal including the touch up event cannot be received from the user device 30 for a predetermined time period, the remote controller control device 12 may perform exception handling by outputting a button-off signal to the remote controller circuit 14 (S604).

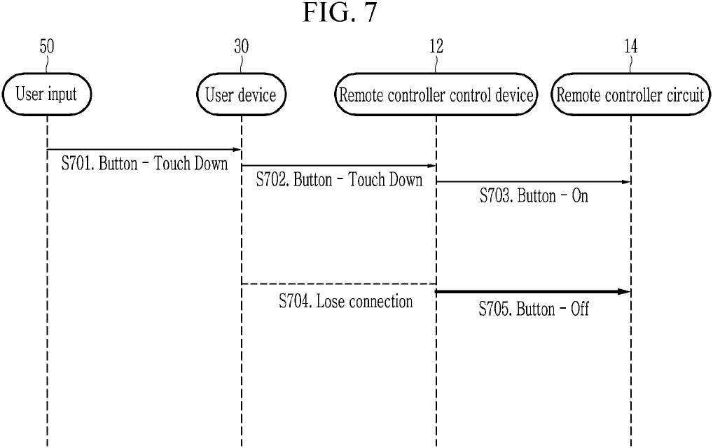

FIG. 7 is provided for description of a key control method according to an embodiment of the present invention.

Referring to FIG. 7, in a key control method for exception handling according to an embodiment of the present invention, when detecting that a connection with the user device 30 is lost, the remote controller control device 12 may output a button off signal for switching at least one button to an off-state to the remote controller circuit 14.

Specifically, as a user input 50, a touch down event for at least one button of the key control device 10 (specifically, the remote controller circuit 14) may occur (S701).

The user device 30 may detect occurrence of a touch down event in the user input 50, and accordingly, may transmit a first button driving signal for driving the key control device 10 to the key control device 10. Specifically, the user device 30 may transmit the first button signal to the remote controller control device 12 through the communication module 126 (S702). Here, the first button driving signal may include a touch down event for at least one button.

The remote controller control device 12 may output a second button driving signal to the remote controller circuit 14 according to the first button driving signal received from the user devices 30 and 32. Here, as the first button driving signal includes a touch down event, the second button driving signal may imply a button-on signal for converting at least one button of the remote controller circuit 14 to the on-state (S703).

However, when the connection with the user device 30 is lost (S704), the remote controller control device 12 may perform exception handling by outputting the button-off signal to the remote controller circuit 14 (S705).

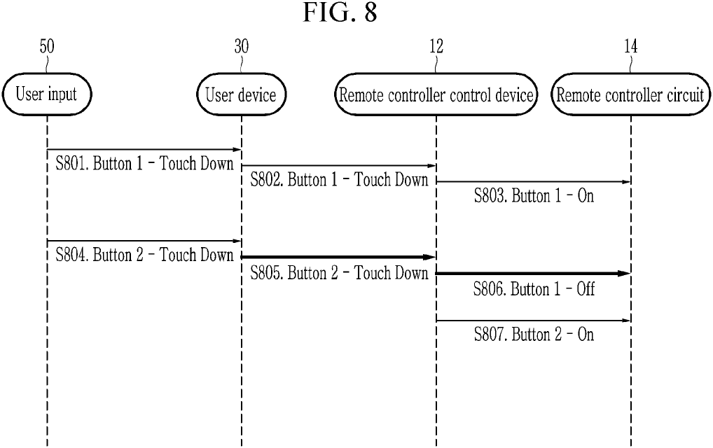

FIG. 8 is provided for description of a key control method according to an embodiment of the present invention.

Referring to FIG. 8, in a key control method for exception handling according to an embodiment of the present invention, when detecting a data loss for a first button driving signal transmitted from the user device 30, the remote controller control device 12 may output a button off signal for switching at least one button to an off-state to the remote controller circuit 14.

Specifically, as a user input 50, a touch down event for a first button of the remote controller circuit 14 of the key control device 10 may occur (S801). In addition, as a first button driving signal for driving the key control device 10, the user device 30 may transmit a signal including a touch down event for the first button to the remote controller control circuit 12 of the key control device 10 (S802). Next, as a second button driving signal, the remote controller control circuit 12 may output a first button on signal for converting the first button to the on-state to the remote controller circuit 14 (S803).

Subsequently, as a user input 50 by the user’s multi-touch, a touch down event for a second button of the remote controller circuit 14 among the key control devices 10 may occur (S804). However, in this case, as previously described with reference to FIG. 4, the user device 30 needs to transmit a signal including a touch down event for a second button as a first button driving signal for driving the key control device 10 to the remote controller circuit 12 of the key control device 10, together with a signal including a touch down event for a first button, but, the user device 30 may transmit only a signal including the touch down even for the second button due to an error (S805).

In this case, the remote controller control circuit 12 may output a second button on signal for switching the second button to on an on-state to the remote controller circuit 14 as a second button driving signal (S807), but the remote controller control circuit 12 may omit a first button off signal for switching the first button to an off-state because it does not receive a touch down event for the first button due to an error.

In order to prevent this, when detecting a data loss for the first button driving signal transmitted from the user device 30, the remote controller control device 12 may output an off signal for switching at least one button to the off-state, that is, a first button off signal for switching the first button to the off-state to the remote controller circuit 14 in the present embodiment (S806).

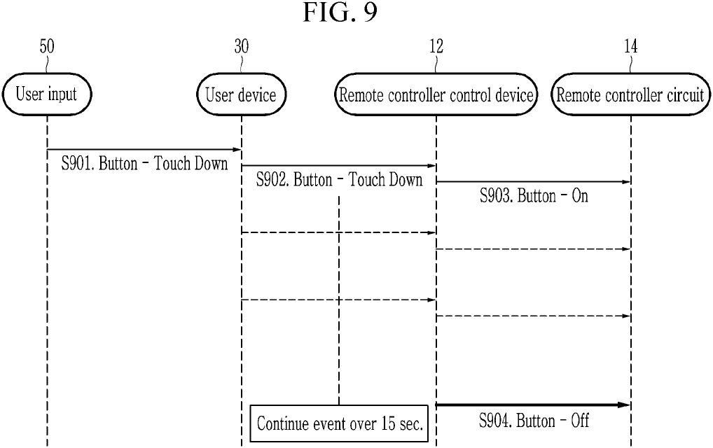

FIG. 9 is provided for description of a key control method according to an embodiment of the present invention.

Referring to FIG. 9, in a key control method for exception handling according to an embodiment of the present invention, when continuously receiving a touch down event from the user device 30 over a predetermined time, the remote controller control device 12 may output a button-off signal for switching at least one button to an off-state to the remote controller circuit 14.

Specifically, as a user input 50, a touch down event for at least one button of the key control device 10 (specifically, the remote controller circuit 14) may occur (S901).

The user device 30 may detect occurrence of a touch down event in the user input 50, and accordingly, may transmit a first button driving signal for driving the key control device 10 to the key control device 10. Specifically, the user device 30 may transmit the first button signal to the remote controller control device 12 through the communication module 126 (S902). Here, the first button driving signal may include a touch down event for at least one button.

The remote controller control device 12 may output a second button driving signal to the remote controller circuit 14 according to the first button driving signal received from the user devices 30 and 32. Here, as the first button driving signal includes a touch down event, the second button driving signal may imply a button-on signal for converting at least one button of the remote controller circuit 14 to the on-state (S903).

However, when continuously receiving the touch down event over a predetermined time (e.g., 15 seconds) from the user device 30, the remote controller control device 12 may perform exception handling by outputting a button-off signal to the remote controller circuit 14 (S904).

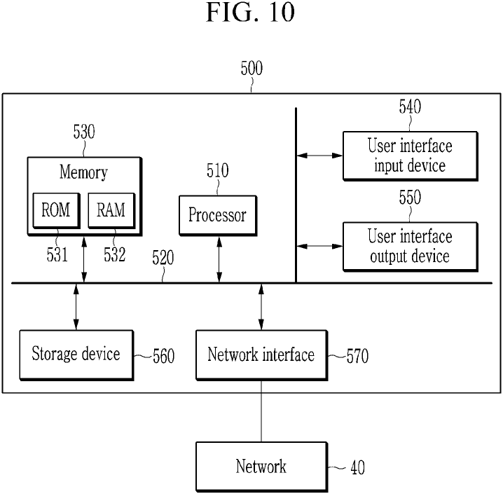

FIG. 10 is a block diagram for description of a computing device for implementing a key control method, a key control device, and a user device according to an embodiment of the present invention.

Referring to FIG. 10, a key control method, a key control device, and a user device according to an embodiment of the present invention may be implemented by using a computing device 500.

The computing device 500 may include at least one of a processor 510, a memory 530, a user interface input device 540, a user interface output device 550, and a storage device 540, which communicate through a bus 520. The computing device 500 may also include a network interface 570 electrically accessing the network 40, for example, a wireless network. The network interface 570 may transmit or receive a signal to or from another object through the network 40.

The processor 510 may be implemented in various types such as an application processor (AP), a central processing unit (CPU), a graphics processing unit (GPU), and the like, and may be any semiconductor device that executes instructions stored in the memory 530 or the storage device 560. The processor 510 may be formed to implement the functions and methods described with reference to FIG. 1 to FIG. 9.

The memory 530 and the storage device 560 may include various types of volatile or non-volatile storage media. For example, the memory may include a read-only memory (ROM) 531 and a random access memory (RAM) 532. In the embodiment of the present invention, the memory 530 may be positioned inside or outside the processor 510, and the memory 530 may be connected to the processor 510 through various known means.

In addition, at least a part of the key control method, the key control device, and the user device according to the embodiments of the present invention may be implemented by a program or software executed by the computing device 500, and the program or software may be stored in a computer-readable medium.

In addition, least a part of the key control method, the key control device, and the user device according to the embodiments of the present invention may be implemented as hardware that can electrically access the computing device 500.

According to the embodiments of the present invention described hereinabove, when controlling a vehicle from a mobile device or a wearable device using a vehicle key, not only the same user experience as actually controlling a physical vehicle key can be provided, but it can also be used for general purposes regardless of the difference in vehicle control methods by different vehicle manufacturers.

While this invention has been described in connection with what is presently considered to be practical embodiments, it is to be understood that the invention is not limited to the disclosed embodiments. On the contrary, it is intended to cover various modifications and equivalent arrangements included within the spirit and scope of the appended claims.

1. A key control method comprising:
receiving a user input from a user;
detecting whether a touch up event or a touch down event has occurred in the user input; and
transmitting a first button driving signal to a key control device when the touch up event or the touch down event occurs,
wherein the key control device includes at least one button for controlling another device, and the first button driving signal controls the at least one button.

2. The key control method of claim 1, wherein
the transmitting comprises,
when the touch down event has occurred, transmitting a signal including the touch down event to the key control device as the first button driving signal.

3. The key control method of claim 1, wherein
the transmitting comprises,
when the touch up event has occurred, transmitting a signal including the touch up event to the key control device as the first button driving signal.

4. The key control method of claim 1, wherein
the at least one button comprises a first button and a second button, and
the transmitting comprises:
(i) when a touch down event for the first button occurs, transmitting a signal including the touch down event for the first button to the key control device as the first button driving signal; and
(ii) in the (i), when a touch down event for the second button occurs, transmitting a signal including a touch down event for the second button to the key control device as the first button driving signal, together with a signal including the touch down event for the first button.

5. The key control method of claim 4, wherein
the transmitting comprises
(iii), in the (ii), when a touch up event for the first button occurs, transmitting a signal including the touch up button for the first button to the key control device as the first button driving signal, together with a signal including a touch down event for the second button.

6. The key control method of claim 5, wherein
the transmitting comprises
(iv) in the (iii), when a touch up event for the second button occurs, transmitting a signal including a touch up event for the second button to the key control device as the first button driving signal.

7. The key control method of claim 1, wherein
the transmitting comprises:
when the touch down event occurs, iteratively transmitting a signal including the touch down event at a predetermined time interval to the key control device as the first button driving signal; and
when the touch up event occurs, transmitting a signal including the touch up event the to the key control device as the first button driving signal.

8. A key control device comprising:
a remote controller control device that receives a first button driving signal including a touch up event or a touch down event from a user device through a communication module, and outputs a second button driving signal according to the touch up event or the touch down event; and
a remote controller circuit that controls another device by applying the second button driving signal received from the remote controller control device to at least one button.

9. The key control device of claim 8, wherein
the remote controller control device outputs a button-on signal for switching the at least one button to an on-state as the second button driving signal when receiving the touch down event.

10. The key control device of claim 8, wherein
the remote controller control device outputs a button-off signal for switching the at least one button to an off-state as the second button driving signal, when receiving the touch up event.

11. The key control device of claim 8, wherein
the at least one button comprises a first button and a second button,
the remote controller control device outputs a first button-on signal for switching the first button to an on-state as the second button driving signal when receiving the touch down event, and
when receiving the touch down event for the second button while outputting the first button-on signal, the remote controller control device outputs a second button-on signal for switching the second button to the on-state as the second button driving signal, together with the first button-on signal.

12. The key control device of claim 11, wherein
when receiving the touch up event for the first button after outputting the first button-on signal and the second button-on signal, the remote controller control device outputs a first button off signal for switching the first button to an off-state as the second button driving signal, together with the second button on signal.

13. The key control device of claim 12, wherein
when receiving the touch up event for the first button after outputting the first button-off signal and the second button-on signal, the remote controller control device outputs a second button off signal for switching the second button to an off-state as the second button driving signal.

14. The key control device of claim 8, wherein
when not receiving a first button driving signal from a user device for a predetermined time period, the remote controller control device outputs a button-off signal for switching the at least one button to an off-state.

15. The key control device of claim 8, wherein
when detecting a connection loss with the user device, the remote controller control device outputs a button-off signal for switching the at least one button to an off-state.

16. The key control device of claim 8, wherein
when detecting a data loss for a first button driving signal transmitted from a user device, the remote controller control device outputs a button-off signal for switching the at least one button to an off-state.

17. The key control device of claim 8, wherein
when continuously receiving a touch down event over a predetermined time, the remote controller control device outputs a button-off signal for switching the at least one button to an off-state.
